(19) United States
(12) Patent Application Publication
(10) Pub. No.: US 2005/0254724 A1
(43) Pub. Date: Nov. 17, 2005

(54) Method and device for error-reduced imaging of an object

(75) Inventors: Markus Seesselberg, Aalen (DE); Johannes-Maria Kaltenbach, Konigsbronn-Ochsenberg (DE)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: Carl Zeiss AG

(21) Appl. No.: 10/896,324

(22) Filed: Jul. 21, 2004

(30) Foreign Application Priority Data
Jul. 23, 2003 (DE) 103 33 712.1-51

(51) Int. Cl. G06K 9/40

(52) U.S. Cl. 382/274

(57) ABSTRACT

A method for imaging an object using an optical device (1), which comprises at least one imaging unit (1.1) and one image recording unit (1.2) having a number of detection regions (3) for detecting intensity values B_{ij,c}, which are representative of the intensity of the light incident on the detection region (3) when imaging the object, to reduce errors, particularly stray light effects, upon imaging the object, a corrected intensity value B_{ij,c,corr} being determined in that a previously determined error correction operator K for the imaging unit (1.1; 1.1′) is applied to the actual intensity value B_{ij,c} detected in the particular detection region (3). A corresponding method for correcting the intensity values B_{ij,c} detected while imaging an object using an optical device and a corresponding method for determining an error correction operator for correcting the intensity values B_{ij,c} detected when imaging an object using an optical device. A corresponding imaging device for performing the method.

### BACKGROUND OF THE INVENTION

The present invention relates to methods and devices for imaging an object using an optical device. In particular, it relates to the reduction of errors when imaging an object.

When imaging objects using optical devices, such as digital cameras, microscopes, or the like, the problem frequently arises that interfering reflection images occur due to reflections within the imaging unit, which leads either to contrast reduction or the occurrence of ghost images. This is also true when using diffractive optical elements in imaging unit, which are winning more and more significance for reasons of volume and weight reduction. In this case, undesired stray light in an amount of 10 to 20% of the useful light frequently occurs, which is scattered by the diffractive element or elements in orders of diffraction for which the imaging unit is not optimized.

In connection with the use of refractive imaging units, devices which are to eliminate these types of reflection images or ghost images through modification or supplementation of the imaging unit through appropriate optical elements are known from U.S. Pat. No. 5,886,823, U.S. Pat. No. 6,124,977, and WO 99/57599 A1. However, the disadvantage arises in this case that the cited errors due to reflection or ghost images may be eliminated only in a relatively complex way, if at all, using such additional optical elements. In addition, these additional optical elements again undesirably increase the overall volume of the imaging unit. Finally, additional optical elements of this type are hardly suitable for reducing the stray light influences when using diffractive optical elements.

In contrast, for imaging devices having digitized image information, performing the correction of imaging errors computationally on the digitized image information is suggested in WO 03/040805 A1 and U.S. 2001/0045988 A1. WO 03/040805 A1, for the special case of invariant imaging errors, which are generated by planar surfaces inside the optical arrangement, suggests performing, for each pixel, a subtraction of weighted intensity values of the remaining pixels, as it is disclosed in U.S. Pat. No. 5,153,926.

With this background, the present invention is based on the object of providing methods and an imaging device, respectively, which does not have the above-mentioned disadvantages or at least has them to a reduced degree and, particularly, ensures, by using simple means, reliable reduction of the errors cited when imaging can object.

### BRIEF SUMMARY OF THE INVENTION

A first object of the present invention is a method for imaging an object using an optical device, which comprises at least one imaging unit and an image recording unit having a number of detection regions for detecting intensity values, B_{ij,c} which are representative of the intensity of the light incident on the detection regions (3) when imaging the object, a corrected intensity value B_{ij,corr} being determined when imaging the object to reduce errors, particularly stray light effects, by applying a previously determined error correction operator K for the imaging unit to the actual intensity value B_{ij,c} detected in the respective detection region.

A second object of the present invention is a method for correcting the intensity values B_{ij,c} detected when imaging an object using an optical device, the optical device comprising at least one imaging unit and an image recording unit having a number of detection regions for detecting the intensity values B_{ij,c}, which are representative of the intensity of the light incident on the detection region when imaging an object, and a corrected intensity value B_{ij,c,corr} being determined to reduce the errors, particularly stray light effects, arising when imaging the object by applying an error correction operator K previously determined for the imaging unit to the actual intensity value B_{ij,c} detected in the respective detection region.

A third object of the present invention is a method for determining an error correction operator K for correcting the intensity values B_{ij,c} detected when imaging an object using an optical device, the optical device comprising at least one imaging unit and one image recording unit having a number of detection regions for detecting the intensity values. B_{ij,c}, which are representative of the intensity of the light incident on the detection region when imaging the object, and the error correction operator K being determined using technical data of the optical device and being adapted for reducing the errors, particularly stray light effects, arising when imaging the object in such a way that, when the error correction operator K is applied to the actual intensity value B_{ij,c} detected in the respective detection region, a corrected intensity value B_{ij,c,corr} for the detection region results.

A third object of the present invention is an imaging device, particularly a digital camera, having at least one optical imaging unit for imaging an object on an image recording unit assigned to the imaging unit and having a processing unit connected to the image recording unit, the image recording unit having a number of detection regions for detecting intensity values which are representative of the intensity of the light incident on the detection region when imaging the object, and the processing unit being adapted for determining a corrected intensity value B_{ij,c,corr} to reduce errors when imaging an object using the imaging unit by applying an error correction operator K determined for the imaging unit to the actual intensity value B_{ij,c} detected in the respective detection region, the error correction operator K being stored in a first memory connected to the processing unit.

The present invention is based on the technical teaching that reliable reduction of errors, particularly stray light effects, is obtained when imaging the object using the optical device if a corrected intensity value B_{ij,c,corr} is determined by applying an error correction operator K previously determined for the imaging unit to an actual intensity value B_{ij,c} detected in the respective detection region. The corrected intensity value B_{ij,c,corr} thus obtained for the respective detection region may then be used for outputting of the image of the object.

In other words, according to the present invention, an intensity function B_{ij,c} represented by the actual intensity values B_{ij,c} detected in the respective detection region is transformed by an error correction operator K previously determined for the imaging unit into a corrected intensity function B_{ij,c,corr} which then reflects the corresponding corrected intensity value B_{ij,c,corr} for the respective detection region.

The present invention makes use of the fact that, in optical devices of this type, having discrete detection regions, such as pixels, of the imaging unit, the image information is first provided in the form of electronic signals anyway, from which the image of the object is only generated later, for example, on a corresponding output unit, such as a display screen or the like. This allows a purely computational correction to be performed without additional optical elements by applying, for the respective detection region, i.e., for the respective pixel in the i^{th} column and the j^{th} line, an error correction operator K previously determined for the relevant imaging unit to the actual detected intensity value B_{ij,c} in order to obtain the corrected intensity value B_{ijc,corr}.

If necessary, if the particular detection region is divided into sub-regions, for example, if a pixel is divided into sub-pixels for different colors c (e.g., red, green, blue), the error correction operator K may be applied separately for each sub-region.

The intensity function B_{ij,c} basically represents the intensity, measured using the image recording unit, as a function of the pixel location (i,j) and the color index c. It is basically the “raw image” of the object, which still contains the errors, such as stray light and reflections, caused by the imaging unit.

The particular error correction operator K may be determined for refractive, reflective, and diffractive imaging units in any arbitrary suitable way. It may also be used for combined imaging units made of refractive, reflective, and diffractive elements in any arbitrary composition. Thus, for example, it may be determined once beforehand and then used again and again upon further use of the optical device. For example, it may be determined even while manufacturing the imaging unit through appropriate measurements on the imaging unit. It may also, of course, be calculated on the basis of the theoretical technical data as well as on the basis of the actual technical data of the imaging unit, such as the geometry data of the optical elements used and the optical properties of the materials used.

The correction of the intensity values may be performed immediately after each recording of the corresponding image, i.e., after each detection of an intensity data set comprising the intensity values of the detection regions.

However, it is also possible to first store the actual detected intensity data of the particular recording temporarily as raw data and only correct it later in the way described. The correction may be performed by the optical device itself, which is then equipped with an appropriate processing unit, or it may also be performed in a processing unit separate from the optical device.

### BRIEF DESCRIPTION OF THE DRAWINGS

FIG. 1 is a schematic illustration of a preferred embodiment of the imaging device according to the present invention for performing the imaging method according to the present invention using the method for determining an error correction operator according to the present invention and the correction method according to the present invention;

FIG. 2 is a schematic illustration of a detail of the image recording unit of the imaging device from FIG. 1;

FIG. 3 is a schematic illustration of a preferred arrangement for performing the correction method according to the present invention using the method for determining an error correction operator according to the present invention.

### DETAILED DESCRIPTION OF THE INVENTION

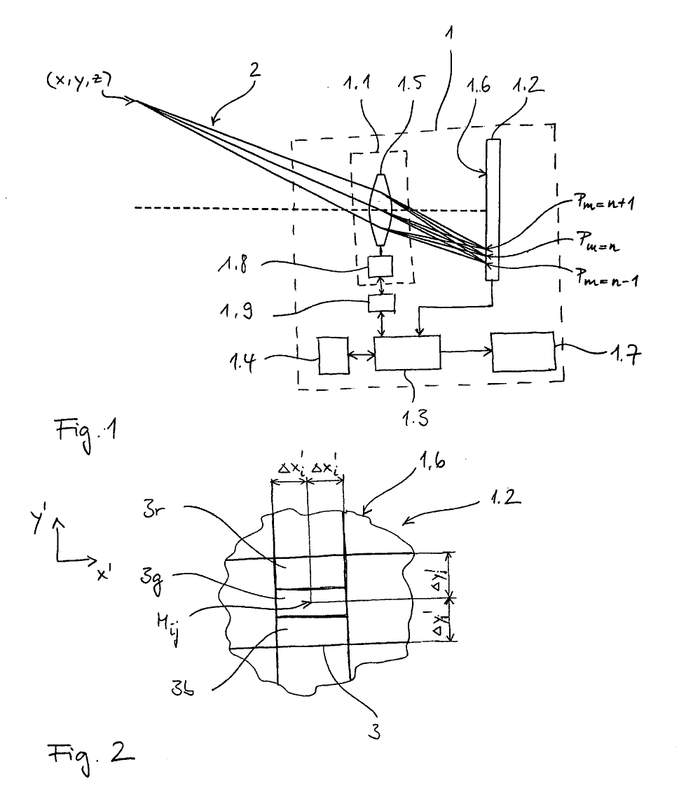

The present invention, which will be described in the following after several general remarks with reference to FIGS. 1 through 3, relates, as noted, to a method for imaging an object using an optical device 1, which comprises at least one imaging unit 1.1 and one image recording unit 1.2 having a number of detection regions 3 for detecting intensity values B_{ij,c}, which are representative of the intensity of the light incident on the detection region 3 when imaging the object. To reduce errors, particularly stray light effects, a corrected intensity value B_{ij,c,corr} is determined when imaging the object by applying an error correction operator K previously determined for the imaging unit to the actual intensity value B_{ij,c} detected in the respective detection unit 3.

Furthermore, the present invention relates to a method for correcting the intensity values B_{ij,c} detected when imaging an object using an optical device 1. The optical device 1, used for detecting the intensity values B_{ij,c} comprises at least one imaging unit 1.1 and one image recording unit 1.2, having a number of detection regions 3 for detecting intensity values B_{ij,c}. The intensity values B_{ij,c} are in turn representative of the intensity of the light incident on the detection region 3 when imaging the object. According to the present invention, to reduce errors, particularly stray light effects, when imaging the object, a corrected intensity value B_{ij,c,corr} is determined by applying an error correction operator K previously determined for the imaging unit to the actual intensity value B_{ij,c} detected in the respective detection region.

Using this correction method, the advantages described above of the imaging method according to the present invention and its embodiments may be implemented to the same degree, so that in this regard reference is made to the above remarks.

Preferably, in a reception step, a first intensity data set comprising the intensity values B_{ij,c}, detected by the optical device 1 is received. Subsequently, in a correction step, the error correction operator K is applied to the intensity values B_{ij,c} of the first intensity data set to determine the respective corrected intensity value B_{ij,c,corr}. Furthermore, a second intensity data set comprising the corrected intensity values B_{ij,c,corr} is generated therefrom. This second intensity data set may then be used to output an image of the object.

The correction method according to the present invention may be performed by a suitable processing device 1.3. In this case, the error correction operator K for a known optical device may be available in the processing device even before receiving the first intensity data set. The error correction operator K may also be received together with the first intensity data set. In other variations, in a step preceding the correction step, technical data of the optical device are received to calculate the error correction operator K and the error correction operator K is determined on the basis of the technical data.

An essential perception upon which the present invention is based is that it is possible to determine a corresponding error correction operator K on the basis of the technical data of an optical device.

The present invention thus additionally relates to a method for determining an error correction operator K for correcting the intensity values B_{ij,c} detected when imaging an object using an optical device 1. The optical device in this case also comprises at least one imaging unit 1.1 and one image recording unit 1.2 having a number of detection regions for detecting the intensity values B_{ij,c}. The intensity values B_{ij,c} are again representative of the intensity of the light incident on the detection region when imaging the object. According to the present invention, the error correction operator K is determined using technical data of the optical device 1. In this case, it is implemented for reducing errors arising when imaging the object, particularly stray light effects, in such a way that when the error correction operator K is applied to an actual intensity value B_{ij,c} detected in the respective detection region 3, a corrected intensity value B_{ij,c,corr} gor the detection region 3 results.

In the following, in particular in regard to determining the error correction operator K, preferred embodiments of all methods described above are described.

Preferably, the error correction operator K is determined from a point spread function P(λ,x,y,z,x′,y′) previously determined for the optical device, which represents a measure of the energy which reaches the location (x′,y′) in the image space from an object point emitting light with the wavelength λ at the location (x,y,z). Using this point spread function, the corresponding error correction operator K—as will be explained in greater detail in the following—may be determined in a particularly simple way.

As noted, the method according to the present invention may be used for any arbitrary type of imaging unit. It is preferably used in connection with imaging units having diffractive elements. Therefore, the error correction operator is preferably a stray light correction operator K for correcting stray light effects when imaging the object using an optical device having at least one imaging diffractive element.

For this purpose, the point spread functions Pₘ(λ,x,y,z,x′,y′) determined for the particular order of diffraction m are preferably used, the order of diffraction for the useful light being identified with m=n. These point spread functions are preferably normalized so that the integral over Pₘ(λ,x,y,z,x′,y′) over the image space precisely corresponds to the diffraction efficiency ηₘ of the diffractive optical element. Therefore:

$${\int }_{- ∞}^{∞} {\int }_{- ∞}^{∞} {P}_{m} ( λ , x , y , z , {x}^{′} , {y}^{′} ) ⅆ {x}^{′} ⅆ {y}^{′} = {η}_{m} ( λ ) with \\ {\sum }_{m} {η}_{m} ( λ ) = 1. \qquad ( 1 )$$

The point spread functions Pₘ(λ,x,y,z,x′,y′) may be determined experimentally for the particular imaging unit. However, they may also be calculated using typical methods for simulating optical systems, for example. Corresponding standard software is available for this purpose, so that this will not be discussed in greater detail here.

As noted above, the error correction operator may also be determined for purely refractive imaging units in order to reduce and/or eliminate errors due to reflections or the like. In this case, the index m does not identify the order of diffraction, but rather the particular surface combination of the imaging unit which leads to a specific point image of an object point.

In preferred variations of the method according to the present invention, use is made of the fact that the point spread functions Pₘ for different orders of diffraction may be added up in regard to their intensity in a good approximation to the point spread function P even when the point spread functions Pₘ for different orders of diffraction overlap one another. This is the case, for example, in the center of the image of a rotationally-symmetric system. In this case, the point spread function Pₙ of the useful light has a very large absolute value in comparison to the point spread functions Pₘ of the other orders of diffraction m≠n. Therefore, at least in a good approximation, the following applies:

$$P ( λ , x , y , z , {x}^{′} , {y}^{′} ) = {\sum }_{m} {P}_{m} ( λ , x , y , z , {x}^{′} , {y}^{′} ) . \qquad ( 2 )$$

Since, as noted above, the point spread functions Pₘ for the individual orders of diffraction may be determined easily, the point spread function P may also be determined easily using this equation or approximation. In this context, one may restrict to the orders of diffraction m neighboring the order of diffraction n of the useful light. Thus, for example, only the respective 5 orders of diffraction neighboring the order of diffraction n of the useful light may be considered, i.e., n−5≦m≦n+5.

In preferred variations of the method according to the present invention, to determine the error correction operator, the continuous point spread function Pₘ(λ,x,y,z,x′,y′) of the optical device for the respective order of diffraction m is thus determined in a first step.

Subsequently, in the course of the first step, the division of the image space into multiple detection regions is taken into account. The detection regions are typically rectangular pixels arranged in a matrix. For this variation of the method according to the present invention, it is assumed that the center of the pixel in the ith column and the jth line is located in the image space at the location (x′ᵢ,y′ⱼ) and the pixel has the dimension 2Δx′ᵢ in the x′-direction and 2Δy′ⱼ in the y′-direction. The discrete point spread function P_{m,ij}(λx,y,z) for the particular order of diffraction m and the respective detection region ij is then determined as

$${P}_{m , ij} ( λ , x , y , z ) = {\int }_{{y}_{j}^{′} - Δ {y}_{j}^{′}}^{{y}_{j}^{′} + Δ {y}_{j}^{′}} {\int }_{{x}_{i}^{′} - Δ {x}_{i}^{′}}^{{x}_{i}^{′} + Δ {x}_{i}^{′}} {P}_{m} ( λ , x , y , z , {x}^{′} , {y}^{′} ) ⅆ {x}^{′} ⅆ {y}^{′} \qquad ( 3 )$$

from the continuous point spread function Pₘ(λ,x,y,z,x′,y′) for the particular order of diffraction m. It is obvious in this case that, in other embodiments of the present invention, another arbitrary design of the detection regions or pixels, respectively, and a different coordinate selection for the center of the pixels may be selected. The dimensions of the pixels may vary from pixel to pixel. However, it is obvious that the pixels typically have the same dimension 2Δx′in the x′-direction and 2Δy′in the y′-direction.

Using equation (2), the connection between the discrete point spread function P_{m,ij}(λ,x,y,z) for the respective order of diffraction and the discrete overall point spread function Pᵢⱼ(x,y,z) also applies here:

$${P}_{ij} ( λ , x , y , z ) = {\sum }_{m} {P}_{m , ij} ( λ , x , y , z ) . \qquad ( 4 )$$

In the present embodiment, the detection region is subdivided into multiple sub-regions for different colors having the color index c, for example, into a green (g), red (r), and blue (b) sub-pixel, respectively, which react with a specific sensitivity E_{c}(λ) to light of the wavelength λ. The position of the particular sub-region in the detection region may also be incorporated into the calculations via a location-dependent sensitivity E_{c}(λ,x′,y′). A separate detection region may also be defined for each color, however. Finally, the intensity values for different colors may be detected sequentially in time with the aid of appropriate devices like a color wheel, wherein time-dependent sensitivities E_{c}(λ,t) might then eventually be used. For reasons of simpler illustration, this differentiation is not shown in the following through corresponding indices, but rather a wavelength-dependent sensitivity E_{c}(λ) is merely noted in each case, while ignoring this differentiation.

In the event of incoherent illumination of the object, as is typically provided in the optical devices considered here, such as photographic devices, microscopes, telescopes, etc., the image of the object results from the integration of the object represented by the object function O(λ,x,y,z) with the point spread function. The object function O(λ,x,y,z) describes the light radiation properties of the object, it being selected suitably in order to account for shadowings due to objects standing in the foreground from the point of view of the imaging unit. The actual intensity function B_{ij,c} for sub-pixels having the color index c in the ith column and the jth line at light of wavelength λ is calculated in this case as:

$$\begin{matrix}{B}_{ij , c} = \int ⅆ x \int ⅆ y \int ⅆ z {\int }_{0}^{∞} ⅆ λ \cdot {E}_{c} ( λ ) \cdot \\ O ( λ , x , y , z ) \cdot {P}_{ij} ( λ , x , y , z ) \\ ≡ {𝒫 [ O ]}_{ij , c} .\end{matrix} \qquad ( 5 )$$

For this purpose, [symbol] [O]_{ij,c} identifies the result of the application of an operator [symbol] to the object function O(λ,x,y,z), which represents a function of the color index c and the pixel location (i, j). In other words, the operator [symbol] maps the object function O(λ,x,y,z), which is a function of the wavelength λand the co-ordinates (x,y,z) of the object point, onto a function of the color index c and the pixel co-ordinates (i, j).

With the definition

$${{𝒫}_{m} [ O ]}_{ij , c} ≡ \int ⅆ x \int ⅆ y \int ⅆ z {\int }_{0}^{∞} ⅆ λ \cdot {E}_{c} ( λ ) \cdot O ( λ , x , y , z ) \cdot {P}_{m , ij} ( λ , x , y , z ) . \qquad ( 6 )$$

and the approximation or equation (2), respectively, the following also applies again here for the connection between the overall function [symbol] [O]_{ij,c}, and the function [symbol] [O]_{ij,c} for the order of diffraction m:

$$\begin{matrix}{𝒫 [ O ]}_{ij , c} = {\sum }_{m} {{𝒫}_{m} [ O ]}_{ij , c} , \\ i . e . , & ( 7 ) \\ \begin{matrix}{B}_{ij , c} ≡ {𝒫 [ O ]}_{ij , c} \\ = {\sum }_{m} {{𝒫}_{m} [ O ]}_{ij , c} \\ = {\sum }_{m} ( \begin{matrix}\int ⅆ x \int ⅆ y \int ⅆ z {\int }_{0}^{∞} ⅆ λ \cdot {E}_{c} ( λ ) \cdot \\ O ( λ , x , y , z ) \cdot {P}_{m , ij} ( λ , x , y , z )\end{matrix} ) .\end{matrix} & ( 8 )\end{matrix}$$

Equation (7) may be resolved to provide the function [symbol] ₙ[O]_{ij,c} for the order of diffraction n of the useful light:

$${{𝒫}_{n} [ O ]}_{ij , c} = {\{ 𝕀 + {\sum }_{{m}_{m \neq n}} {𝒫}_{m} {𝒫}_{n}^{- 1} \}}^{- 1} {𝒫 [ O ]}_{ij , c} . \qquad ( 9 )$$

In this case, [symbol] ₙ⁻¹ represents the inverse or pseudo-inverse of the operator [symbol] ₙ. The inverse or pseudo-inverse [symbol] ₙ⁻¹ maps a discrete function of the color index c and the pixel co-ordinates (i,j) onto a discrete object function O(λ,x,y,z), which is a function of the wavelength λ and the co-ordinates (x,y,z) of the object point. Depending on whether this is an actual inverse or a pseudo-inverse, this mapping occurs exactly or approximately.

Furthermore, [symbol] ₘ [symbol] ₙ⁻¹ represents a concatenation of the operators [symbol] ₘ and ( [symbol] ₙ⁻¹, which maps a discrete function of the color index c and the pixel co-ordinates (i, j) onto another discrete function of the color index c and the pixel co-ordinates (i,j).

The expression

$$𝕀 + {\sum }_{{m}_{m \neq n}} {𝒫}_{m} {𝒫}_{n}^{- 1}$$

represents, with the unity operator or one operator [symbol] , an operator which also maps a discrete function of the color index c and the pixel co-ordinates (i,j) onto another discrete function of the color index c and the pixel co-ordinates (i,j).

The expression

$${\{ 𝕀 + {\sum }_{{m}_{m \neq n}} {𝒫}_{m} {𝒫}_{n}^{- 1} \}}^{- 1}$$

finally represents the inverse or pseudo-inverse of the operator

$$+ {\sum }_{\begin{matrix}m \\ m \neq n\end{matrix}} {𝒫}_{m} {𝒫}_{n}^{- 1} .$$

This inverse or pseudo-inverse in turn maps a discrete function of the color index c and the pixel co-ordinates (i,j) onto another discrete function of the color index c and the pixel co-ordinates (i,j).

If one discretizes the integrals of the equation systems 5 and 6, the operators [symbol] and [symbol] ₘ may be represented in matrix form. In this case, the operators [symbol] and [symbol] ₘ and the associated matrices, respectively, are not dependent on the object function O(λ,x,y,z), but rather only dependent on the point spread function Pₘ(λ,x,y,z,x′,y′) of the imaging unit and on the sensitivity function E_{c}(λ) of the image recording unit. The operators [symbol] and [symbol] ₘ and the concatenations, inverses, or pseudo-inverses formed therefrom may thus be determined once for the optical device or imaging device, respectively, during manufacturing, for example.

The left part of the equation (9), i.e., the function [symbol] ₙ[O]_{ij,c} for the order of diffraction n of the useful light, represents the intensity function for the pixel of the ith column and the jth line having the color c, which would be obtained if the diffractive imaging unit diffracted all light in the order of diffraction n of the useful light. The function [symbol] ₙ[0]_{ij,c} accordingly represents the image that would be obtained if there was no stray light of the diffractive element of the imaging unit. In other words, the value of the function [symbol] ₙ[O]_{ij,c} for the sub-pixel having the color index c in the ith column and the jth line corresponds to the corrected intensity value B_{ij,c,corr} for this sub-pixel. Therefore, the following equation applies for the intensity function:
B_{ij,c,corr}=[O]_{ij,c}. (10)

In a second step of this embodiment of the method according to the present invention following the first step, the inverse or pseudo-inverse [symbol] ₙ⁻¹ of the first operator [symbol] ₙ is therefore determined. For this first operator [symbol] ₙ, the following equation applies using the order of diffraction n of the useful light, the object function O(λ,x,y,z) describing the radiation properties of an object, and the sensitivity E_{c}(λ) of the particular detection region ij for the color c at the wavelength λ:

$${{𝒫}_{n} [ O ]}_{ij , c} ≡ \int ⅆ x \int ⅆ y {\int }_{0}^{∞} ⅆ λ \cdot {E}_{c} ( λ ) \cdot O ( λ , x , y ) \cdot {P}_{n , ij} ( λ , x , y ) \qquad ( 11 )$$

Finally, in a third step, for the second operator

$$\{ + {\sum }_{\begin{matrix}m \\ m \neq n\end{matrix}} {𝒫}_{m} {𝒫}_{n}^{- 1} \}$$

and using the order of diffraction n of the useful light and the orders of diffraction m≠n, the inverse or pseudo-inverse is determined as the error correction operator K for the imaging unit. Therefore, the following equation applies:

$$K = {\{ + {\sum }_{\begin{matrix}m \\ m \neq n\end{matrix}} {𝒫}_{m} {𝒫}_{n}^{- 1} \}}^{- 1} . \qquad ( 12 )$$

If the equations (5), (10), and (12) are inserted into the equation (9), it becomes clear that, using the error correction operator K, through its simple application to the actual detected intensity value B_{ij,c}, the corrected intensity value B_{ij,c,corr} for the particular detection region, i.e., in this case the sub-pixel having the color index c in the ith column and jth line, may be calculated as
B_{ij,c,corr}=KB_{ij,c} (13)

In other words, this also applies for the connection between the actual detected intensity function B_{ij,c} and the corrected intensity function B_{ij,c,corr}.

The equations (9) and (12) assume that in each case an inverse to the first and second operators exists. If this is not the case or if the determination of the inverses is a poorly conditioned problem which makes the determination more difficult, instead of the inverses of the first and second operator, respectively, a pseudo-inverse may be used, as noted above. Well-known mathematical methods are available for determining such pseudo-inverses, which will not be discussed in greater detail here. Such methods are described, for example, in D. Zwillinger (Editor), “Standard Mathematical Tables and Formulae”, pp. 129-130, CRC Press, Boca Raton, 1996, and in K. R. Castlemann, “Digital Image Processing”, Prentice Hall, 1996. Furthermore, the second operator may be conceived as a 1-operator with interference, which makes inverting it easier in a known way.

The error correction operator must be determined only one single time, as noted, and may then always be used for correcting the imaging of an arbitrary number of different objects. As already noted above, the particular error correction operator may be determined through calculation in purely theoretical ways by employing technical data of the optical device. For this purpose, theoretical or even practically determined geometry data and other optical characteristic values of the optical elements of the imaging unit may be used, for example.

However, it is also obvious that the particular error correction operator may also be determined at least partially experimentally, i.e., using measurement results which originate from measurements on the imaging unit or its optical elements, respectively. In other words, the error correction operator may be determined using data obtained by measuring the optical device. This has the advantage that deviations of the optical elements from their theoretical properties may also be detected, so that the correction also comprises such errors of the imaging unit. Thus, for example, the discrete point spread function P_{m,ij}(λ,x,y,z) for the particular order of diffraction m and the particular detection region D described by equation (3) may be measured. It is obvious that in this case, if necessary, data determined in experimental ways may be combined with theoretically predefined data.

As described above, the present invention allows rapid and simple correction of imaging errors caused by stray light in an exclusively calculatiory way without additional construction outlay. It is obvious that for this purpose further known methods for image restoration may additionally be applied, for example, for compensating for a focus deviation, etc., as are known, for example, from K. R. Castlemann, “Digital Image Processing”, Prentice Hall, 1996. The corrected intensity value B_{ij,c,corr} for the respective detection region, such as the respective pixel, may then be used for the output of the image of the object. Thus, for example, on the basis of the corrected intensity values B_{ij,c,corr} a corresponding image of the object may be displayed on a display screen or the like or in a printout, respectively. However, a conventional film or the like may also be exposed on the basis of these corrected intensity values B_{ij,c,corr}.

The present invention further relates to an imaging device 1, particularly a digital camera, which has at least one optical imaging unit 1.1 for imaging an object on an image recording unit 1.2 assigned to the imaging unit and a processing unit 1.3 connected to the image recording unit 1.2. The image recording unit comprises a number of detection regions 3 for detecting intensity values which are representative of the intensity of the light incident on the detection region 3 when imaging the object. According to the present invention, for reducing errors when imaging an object using the imaging unit, the processing unit is adapted to determine a corrected intensity value B_{ijmc,corr} by applying an error correction operator K determined for the imaging unit to the actual intensity value B_{ij,c} detected in the particular detection region. In this case, the error correction operator K is stored in a first memory 1.4 connected to the processing unit.

Using this imaging device, which represents an optical device in accordance with the method according to the present invention described above, the advantages of the imaging method according to the present invention and its embodiments, as described above, may be achieved to the same degree, so that in this regard reference is made to the above remarks. In particular, the method according to the present invention may be performed using this imaging device.

In principle, the imaging device according to the present invention may be designed in any arbitrary way. Thus, its imaging unit may exclusively comprise one or more refractive elements or may as well exclusively comprise one or more diffractive elements. The imaging unit may also, of course, comprise a combination of refractive and diffractive elements.

As described above in connection with the method according to the present invention, the present invention may be used for imaging units having refractive, reflective, and diffractive elements in any arbitrary combination. It may be used especially advantageously in connection with diffractive imaging devices. The imaging unit therefore preferably comprises at least one imaging diffractive element. The error correction operator is then a stray light correction operator K for correcting stray light effects when imaging the object on the image recording unit.

The respective error correction operator may, as noted, be determined once and then stored in the first memory for further use for any arbitrary number of object images using the imaging device. This may be performed, for example, directly during the manufacturing or at a later point in time before or after delivery of the imaging device. The first memory may also be able to be overwritten in order to possibly update the error correction operators at any arbitrary later point in time via a corresponding interface of the imaging device.

In preferred designs of the imaging device according to the present invention, the processing unit itself is implemented for determining the error correction operator K for the particular detection region using stored technical data of the imaging unit. This technical data of the imaging unit may be geometry data necessary for calculating the error correction operator and other optical characteristic data of the optical elements of the imaging unit.

This is especially advantageous if the imaging device is provided with a replaceable imaging unit, i.e., if different imaging units may be used. In this case, the technical data of the relevant imaging unit may then be input into the processing unit via an appropriate interface in order to calculate the error correction operators. The technical data of the imaging unit is preferably stored in a second memory, connected to the imaging unit, which is connected to the processing unit, preferably automatically, when the imaging unit is mounted on the imaging device.

For displaying the image of the object, the intensity values B_{ij,c,corr} determined in the imaging device may be read out of the imaging device via a corresponding interface. Especially advantageous embodiments of the imaging device according to the present invention are characterized in that an output unit connected to the processing unit is provided for the output of the image of the object, the processing unit being adapted to use the corrected intensity values B_{ij,c,corr} when outputting the image of the object.

The imaging device according to the present invention may be used for any arbitrary imaging tasks. The imaging device according to the present invention is preferably a digital camera, a telescope, a night vision device, or a component of a microscope, such as an operation microscope or the like. The methods according to the present invention may also be used in connection with imaging devices of this type.

Further preferred embodiments of the present invention result from the dependent claims or the following detailed description of a preferred embodiment, respectively.

FIG. 1 shows a schematic illustration of a preferred embodiment of the imaging device 1 according to the present invention for performing the imaging method according to the present invention using the method for determining an error correction operator according to the present invention and the correction method according to the present invention. The imaging device 1 comprises a schematically illustrated imaging unit 1.1, an image recording unit 1.2, and a processing unit 1.3, connected to the image recording unit 1.2, which is in turn connected to a first memory 1.4.

The imaging unit 1.1 in turn comprises, among others, a—schematically illustrated—diffractive optical element 1.5, via which the object point (x,y,z) having the co-ordinates (x,y,z) in the object space is imaged on the surface 1.6 of the image recording unit 1.2. In this case, a beam bundle 2 is emitted from the object point (x,y,z), which is imaged by the diffractive optical element 1.5 for every non-disappearing order of diffraction m on a point Pₘ on the surface 1.6. In this case, particularly for the orders of diffraction m≠n, the object point may be imaged non-focused, i.e., imaged on a disk-shaped region. In FIG. 1, for simplification, only the point Pₘ₌ₙ for the order of diffraction m=n of the useful light and the points Pₘ₌ₙ₋₁ and Pₘ₌ₙ₊₁ for the neighboring orders of diffraction m=n−1 and m=n+1 are illustrated. Due to this imaging at different orders of diffraction, undesired stray light effects, such as ghost images or the like, occur in the region of the image recording unit 1.2.

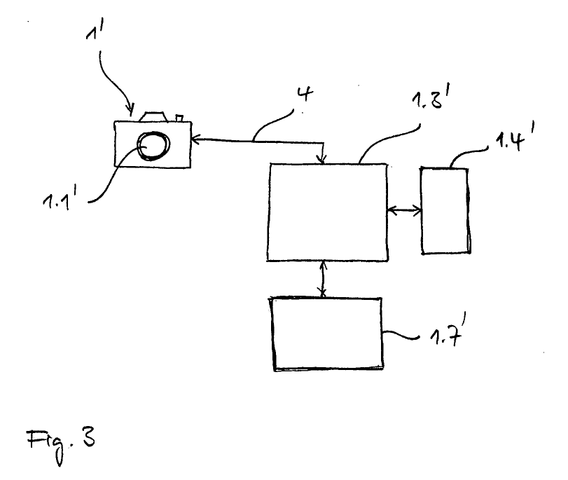

As may be seen from FIG. 2, the surface 1.6 of the image recording unit 1.2 has an array of detection regions in the form of rectangular pixels 3 positioned in a matrix. The center Mᵢⱼ of the particular pixel 3 is at the co-ordinates (x′ᵢ,y′ⱼ) in the ith column and jth line of the pixel matrix. In this case, the pixel 3 has the dimensions 2Δx′ᵢ and 2Δy′ᵢ, Δx′ᵢ and Δy′ⱼ having the same value for all pixels.

For the three colors red, green, and blue, each pixel 3 has a red sub-pixel 3r, a green sub-pixel 3g, and a sub-pixel 3b, which react with a specific sensitivity E_{c}(λ) to light of the wavelength λ, the color index c being able to assume the values r (red), g (green), and b (blue). For each pixel 3, three sensitivity functions E_{c}(λ) are therefore predefined. For each of the three colors, the pixel 3 detects an intensity value B_{ij,c}, which is representative of the intensity of the light incident on the relevant pixel 3 when imaging the object O.

In order to reduce the errors described above due to the stray light caused by diffraction, an error correction operator in the form of a stray light correction operator K is stored in the first memory 1.4 for the imaging unit 1.1. When imaging an object, the processing unit 1.3 accesses the error correction operator K in the first memory 1.4. It applies the error correction operator K, according to the correction method according to the present invention, to the particular actual intensity value B_{ij,c} detected by the pixel 3 and thus obtains a corrected intensity value B_{ij,c,corr} for each color c. The processing unit 1.3 subsequently uses this corrected intensity value B_{ij,c,corr} in order to display the image of the object on an output unit in the form of a display 1.7 connected to the processing unit 1.3.

As is described in the following, the error correction operator K was determined beforehand by the processing unit 1.3 in accordance with the method for determining an error correction operator according to the present invention and stored in the first memory 1.4.

By accessing the first memory 1.4 and a second memory 1.8, which is connected to the processing unit 1.3 via an interface 1.9, the processing unit 1.3 first determines, in a first step, the continuous point spread function Pₘ(λ,x,y,z,x′,y′) of the imaging unit and the discrete point spread functions

$${P}_{m , ij} ( λ , x , y , z ) = {\int }_{{y}_{j}^{′} - Δ {y}_{j}^{′}}^{{y}_{j}^{′} + Δ {y}_{j}^{′}} {\int }_{{x}_{i}^{′} - Δ {x}_{i}^{′}}^{{x}_{i}^{′} + Δ {x}_{i}^{′}} {P}_{m} ( λ , x , y , z , {x}^{′} , {y}^{′} ) ⅆ {x}^{′} ⅆ {y}^{′}$$

(see equation 3) for the respective pixel 3 in the ith column and the jth line of the pixel matrix and the respective order of diffraction m. In this case, the technical data of the imaging unit 1.1 necessary for this purpose, such as the geometry data and other optical characteristic data of the optical element 1.5, are stored in the second memory 1.8. The software for calculating the continuous point spread function Pₘ(λ,x,y,z,x′,y′) is stored in the first memory 1.4. However, it is obvious that, with other embodiments of the present invention, the point spread functions Pₘ(λ,x,y,z,x′,y′) may also be stored directly in the first memory.

Subsequently, in a second step, the processing unit 1.3 first determines, using the order of diffraction n of the useful light, one of the radiation properties of a suitable object function O(λ,x,y,z), and the sensitivity E_{c}(λ) of the particular pixel 3 for the color c at the wavelength λ, the first operator [symbol] ₙ, for which applies, according to equation 6:

$${{𝒫}_{n} [ O ]}_{ij , c} ≡ \int ⅆ x \int ⅆ y \int ⅆ z {\int }_{0}^{∞} ⅆ λ \cdot {E}_{c} ( λ ) \cdot O ( λ , x , y , z ) \cdot {P}_{n , ij} ( λ , x , y , z )$$

and subsequently determines the inverse [symbol] ₙ⁻¹ thereof. For this purpose, the sensitivity functions E_{c}(λ) may also be stored in the first memory 1.4.

In order to be able to represent the operator [symbol] ₘ in matrix form, the integral in equation 6 is discretized. The matrix associated with the operator [symbol] ₘ is then no longer depending on the object function O(λ,x,y,z), but rather only on the point spread functions Pₘ(λ,x,y,z,x′,y′) of the imaging unit 1.1 and on the sensitivity functions E_{c}(λ) of the image recording unit 1.2. The operator [symbol] ₘ and the concatenations, inverses or pseudo-inverses produced therefrom may thus be determined once for the imaging device 1.

Finally, in a third step, the processing unit 1.3 first determines the second operator

$$\{ + {\sum }_{\begin{matrix}m \\ m \neq n\end{matrix}} {𝒫}_{m} {𝒫}_{n}^{- 1} \}$$

using the order of diffraction n of the useful light and the orders of diffraction m≠n. Subsequently, it determines the inverse of the second operator as the error correction operator K for the imaging unit 1.1 according to the above equation (12). Thus:

$$K = {\{ + {\sum }_{\begin{matrix}m \\ m \neq n\end{matrix}} {𝒫}_{m} {𝒫}_{n}^{- 1} \}}^{- 1} .$$

The error correction operator K is then, as noted above, stored in the first memory 1.4 for the imaging unit 1.1 and used in the way described above when determining the corrected intensity values B_{ij,c,corr}.

In the present example, it was assumed that both the inverse of the first operator and the inverse of the second operator exist. However, it is obvious that in other embodiments of the present invention, particularly in those embodiments in which inverses of this type do not exist or may only be determined with increased complexity, pseudo-inverses may be determined instead of the particular inverses using the well-known mathematical methods described above.

In the present example, the imaging unit 1 is a digital camera having a replaceable objective as the imaging unit 1.5. The second memory 1.8 is a memory chip which is attached to the objective and is connected to the interface 1.9 and therefore to the processing unit 1.3 when the objective is mounted to the digital camera. As soon as this is the case, the calculation and storage of the error correction operator K described above is initiated automatically, so that shortly after the objective is mounted, the correct error correction operator K is provided in the first memory 1.4.

The present invention, particularly the method according to the present invention, was described above on the basis of an example in which the error correction operator was determined by the imaging unit 1 in an exclusively calculatory way. However, it is obvious that, with other embodiments of the present invention, the error correction operator may also be determined externally once and then possibly stored in the imaging device. In this case, it may also possibly be determined using corresponding measurement results on the imaging device, particularly the imaging unit. This may be useful for imaging devices having an unchangeable assignment between imaging unit and image recording unit, such as a digital camera having a non-replaceable objective.

FIG. 3 shows a schematic illustration of a preferred arrangement for performing the correction method according to the present invention using the method for determining an error correction operator according to the present invention.

In this case, an imaging device in the form of a digital camera 1′ is connected at least some of the time to a processing unit 1.3′ via a data connection 4. The digital camera 1′ comprises an imaging unit in the form of an objective 1.1′ and an image recording unit (not shown), which correspond to those from FIG. 1. In contrast to the embodiment from FIG. 1, the digital camera does not perform the correction of the errors itself when imaging an object using the objective 1.1′. Rather, the intensity values B_{ij,c} for each recording, which are subject to error, are merely stored in the digital camera 1′.

To correct the intensity values B_{ij,c}, they are relayed as a first intensity data set for the particular recording to the external processing unit 1.3′ via the connection 4 and received by this unit in a reception step. It is obvious in this case that, with other embodiments of the present invention, the transmission of the intensity data may also be performed in any other arbitrary way, for example, via appropriate replaceable storage media, etc.

In order to reduce the errors due to stray light caused by diffraction, which were described above in connection with the embodiment from FIG. 1, an error correction operator is stored, in the form of a stray light correction operator K, in a first memory 1.4′ for the imaging unit 1.1 connected to the external processing unit 1.3′. This stray light correction operator K may have been determined by the imaging device 1′ in the way described above in connection with the embodiment from FIG. 1 and transmitted together with the intensity data. However, it is obvious that, with other embodiments of the present invention, the stray light correction operator K may also be determined by the processing unit 1.3′ in the way described above. Thus, it may be provided that, in a step preceding the correction, technical data of the digital camera 1′ are received to calculate the error correction operator K and the error correction operator K is determined on the basis of the technical data.

In the correction of the transmitted intensity values B_{ij,c} according to the present invention, which are subject to error, for the particular recording of an object, in a correction step, the processing unit 1.3′ accesses the error correction operator K in the first memory 1.4′. In accordance with the correction method according to the present invention, it applies the error correction operator K to the particular actual intensity value B_{ij,c} detected by the relevant pixel and thus obtains a corrected intensity value B_{ij,c,corr} for each color c. The processing unit 1.3′ produces a corrected, second intensity data set for each recording from these corrected intensity values B_{ij,c,corr} and stores it in the first memory 1.4′.

This corrected, second intensity data set may then be used to display the corresponding image of the object on an output unit in the form of a display 1.7′ connected to the processing unit 1.3′. The output unit may also be a photo printer or the like. The corrected, second intensity data set may also be simply output into a corresponding data memory.

The present invention was described above on the basis of examples in which the intensity values B_{ij,c} were detected by image recording units having discrete detection regions as raw data having discrete values and were processed further subsequently. However, it is obvious that the correction method according to the present invention may also be used in connection with common films. Thus, for example, a film exposed and developed in a typical way may be scanned by an appropriate device, from which the discrete intensity values B_{ij,c} then result. Using the known properties of the imaging unit and the known sensitivity of the film, the error correction operator and thus the corrected intensity values B_{ij,c,corr} may then be determined. These corrected intensity values B_{ij,c,corr} may then be used to produce the prints or the like.

1. A method for imaging an object using an optical device comprising at least one imaging unit and one image recording unit having a number of detection regions for detecting intensity values B_{ij,c} which are representative of the intensity of the light incident on the detection region when imaging the object, wherein, to reduce errors, particularly stray light effects, upon imaging the object, a corrected intensity value B_{ij,c,corr} is determined in that a previously determined error correction operator K for the imaging unit is applied to the actual intensity value B_{ij,c} detected in the respective detection region.

2. The method according to claim 1, wherein the error correction operator K is determined from a point spread function P(λ,x,y,z,x′,y′) previously determined for the optical device.

3. The method according to claim 2, wherein the error correction operator is a stray light correction operator K for correcting stray light effects while imaging the object using an optical device having at least one imaging diffractive element.

4. The method according to claim 3, wherein the error correction operator is determined using the approximation that the point spread function P(λ,x,y,z,x′,y′) of the optical device is calculated from the sum of the point spread functions [symbol] ₘ(λx,y,z,x′,y′) of the optical device for the different orders of diffraction m as:
$$P ( λ , x , y , z , {x}^{′} , {y}^{′} ) = {\sum }_{m} {P}_{m} ( λ , x , y , z , {x}^{′} , {y}^{′} )$$

5. The method according to claim 3, wherein, to determine the error correction operator,
in a first step, the continuous point spread function Pₘ(λ,x,y,z,x′,y′) of the optical device is determined and the discrete point spread function P_{m,ij}(λ,x,y,z) for the particular detection region ij is determined for the respective order of diffraction m as:
$${P}_{m , ij} ( λ , x , y , z ) = {\int }_{{y}_{j}^{′} - Δ {y}_{j}^{′}}^{{y}_{j}^{′} + Δ {y}_{j}^{′}} {\int }_{{x}_{i}^{′} - Δ {x}_{i}^{′}}^{{x}_{i}^{′} + Δ {x}_{i}^{′}} {P}_{m} ( λ , x , y , z , {x}^{′} , {y}^{′} ) ⅆ {x}^{′} ⅆ {y}^{′}$$
in a second step, the inverse or pseudo-inverse [symbol] ₙ⁻¹ of a first operator [symbol] ₙ is determined, for which, using the order of diffraction n of the useful light, the object function O(λ,x,y,z) describing the radiation properties of an object, and the sensitivity E_{c}(λ) of the respective detection region ij for the color c at the wavelength λ, the following applies:
$${{𝒫}_{n} [ O ]}_{ij , c} ≡ \int ⅆ x \int ⅆ y \int ⅆ z {\int }_{0}^{∞} ⅆ λ \cdot {E}_{c} ( λ ) \cdot O ( λ , x , y , z ) \cdot {P}_{n , ij} ( λ , x , y , z ) ,$$
and,
in a third step, for a second operator
$$\{ {+ \sum }_{{m}_{m \neq n}} {𝒫}_{m} {𝒫}_{n}^{- 1} \}$$
using the order of diffraction n of the useful light and the orders of diffraction m≠n and the one-operator [symbol] , the inverse or pseudo-inverse
$$K = {\{ {+ \sum }_{{m}_{m \neq n}} {𝒫}_{m} {𝒫}_{n}^{- 1} \}}^{- 1}$$
is determined as the error correction operator K.

6. The method according to claim 1, wherein the error correction operator is determined by calculation using technical data of the optical device.

7. The method according to claim 1, wherein the error correction operator is determined using technical data obtained through measurement of the optical device.

8. A method for correcting the intensity values B_{ij,c} detected when imaging an object using an optical device, the optical device (1, 1′) comprising at least one imaging unit and one image recording unit having a number of detection regions for detecting the intensity values B_{ij,c}, which are representative of the light incident on the detection region when imaging the object, characterized in that, to reduce errors arising when imaging the object, particularly stray light effects, a corrected intensity value B_{ij,c,corr} is determined, in that an error correction operator K previously determined for the imaging unit is applied to the actual intensity value B_{ij,c} detected in the particular detection region.

9. The method according to claim 8, characterized in that
in a reception step, a first intensity data set, comprising intensity values B_{ij,c} detected by the optical device, is received, and
in a correction step, to determine the particular corrected intensity value B_{ij,corr}, the error correction operator K is applied to the intensity values B_{ij,c} of the first intensity data set, and a second intensity data set comprising the corrected intensity data values B_{ij,corr}, is generated.

10. The method according to claim 9, characterized in that, in a step preceding the correction step,
the error correction operator K is received or
technical data of the optical device for calculating the error correction operator K is received and the error correction operator K is determined on the basis of the technical data.

11. The method according to claim 8, wherein the error correction operator K is determined from a point spread function P(λ,x,y,z,x′,y′) previously determined for the optical device.

12. The method according to claim 11, wherein the error correction operator is a stray light correction operator K for correcting stray light effects while imaging the object using an optical device having at least one imaging diffractive element.

13. The method according to claim 12, wherein the error correction operator is determined using the approximation that the point spread function P(λ,x,y,z,x′,y′) of the optical device is calculated from the sum of the point spread functions Pₘ(λ,x,y,z,x′,y′) of the optical device for the different orders of diffraction m as:
$$P ( λ , x , y , z , {x}^{′} , {y}^{′} ) = {\sum }_{m} {P}_{m} ( λ , x , y , z , {x}^{′} , {y}^{′} ) .$$

14. The method according to claim 12, wherein, to determine the error correction operator,
in a first step, for the respective order of diffraction m, the continuous point spread function Pₘ(λ,x,y,z,x′,y′) of the optical device is determined and the discrete point spread function P_{m,ij}(λ,x,y,z) for the particular detection region ij is determined as:
$${P}_{m , ij} ( λ , x , y , z ) = {\int }_{{y}_{j}^{′} - Δ {y}_{j}^{′}}^{{y}_{j}^{′} + Δ {y}_{j}^{′}} {\int }_{{x}_{j}^{′} - Δ {x}_{j}^{′}}^{{x}_{j}^{′} + Δ {x}_{j}^{′}} {P}_{m} ( λ , x , y , z , {x}^{′} , {y}^{′} ) ⅆ {x}^{′} ⅆ {y}^{′}$$
in a second step, the inverse or pseudo-inverse [symbol] ₙ⁻¹ of a first operator [symbol] ₙ is determined, for which, using the order of diffraction n of the useful light, the object function O(λ,x,y,z) describing the radiation properties of an object, and the sensitivity E_{c}(λ) of the respective detection region ij for the color c at the wavelength λ, the following applies:
$${{𝒫}_{n} [ O ]}_{ij , c} ≡ \int ⅆ x \int ⅆ y \int ⅆ z {\int }_{0}^{∞} ⅆ λ \cdot {E}_{c} ( λ ) \cdot O ( λ , x , y , z ) \cdot {P}_{n , ij} ( λ , x , y , z ) ,$$
and,
in a third step, for a second operator
$$\{ {+ \sum }_{{m}_{m \neq n}} {𝒫}_{m} {𝒫}_{n}^{- 1} \}$$
using the order of diffraction n of the useful light and the orders of diffraction man and the one-operator [symbol] , the inverse or pseudo-inverse
$$K = {\{ {+ \sum }_{{m}_{m \neq n}} {𝒫}_{m} {𝒫}_{n}^{- 1} \}}^{- 1}$$
is determined as the error correction operator K.

15. The method according to claim 8, wherein the error correction operator is determined through calculation using technical data of the optical device.

16. The method according to claim 8, wherein the error correction operator is determined using technical data obtained through measurement of the optical device.

17. A method for determining an error correction operator K for correcting the intensity values B_{ij,c} detected when imaging an object using an optical device, the optical device comprising at least one imaging unit and one image recording unit having a number of detection regions for detecting the intensity values B_{ij,c}, which are representative of the intensity of the light incident on the detection region when imaging the object, characterized in that the error correction operator K is determined using technical data of the optical device and is adapted for reducing errors, particularly stray light effects, arising when imaging the object in such a way that, when the error correction operator K is applied to an actual intensity value B_{ij,c} detected in the respective detection region, a corrected intensity value B_{ij,c,corr} for the detection region results.

18. The method according to claim 17, wherein the error correction operator K is determined from a point spread function P(λ,x,y,z,x′,y′) previously determined for the optical device.

19. The method according to claim 18, wherein the error correction operator is a stray light correction operator K for correcting stray light effects when imaging the object using an optical device having at least one imaging diffractive element.

20. The method according to claim 19, wherein the error correction operator is determined using the approximation that the point spread function P(λ,x,y,z,x′,y′) of the optical device is calculated from the sum of the point spread functions Pₘ(λ,x,y,z,x′,y′) of the optical device for the different orders of diffraction m as:
$$P ( λ , x , y , z , {x}^{′} , {y}^{′} ) = {\sum }_{m} {P}_{m} ( λ , x , y , z , {x}^{′} , {y}^{′} ) .$$

21. The method according to claim 19, wherein, to determine the error correction operator,
in a first step, for the respective order of diffraction m, the continuous point spread function P_{m,ij}(λ,x,y,z,x′,y′) of the optical device is determined and the discrete point spread function P_{m,ij}(λ,x,y,z) for the particular detection region ij is determined as:
$${P}_{m , ij} ( λ , x , y , z ) = {\int }_{{y}_{j}^{′} - Δ {y}_{j}^{′}}^{{y}_{j}^{′} + Δ {y}_{j}^{′}} {\int }_{{x}_{j}^{′} - Δ {x}_{j}^{′}}^{{x}_{j}^{′} + Δ {x}_{j}^{′}} {P}_{m} ( λ , x , y , z , {x}^{′} , {y}^{′} ) ⅆ {x}^{′} ⅆ {y}^{′}$$
in a second step, the inverse or pseudo-inverse [symbol] ₙ⁻¹ of a first operator [symbol] ₙ is determined, for which, using the order of diffraction n of the useful light, the object function O(λ,x,y,z) describing the radiation properties of an object, and the sensitivity E_{c}(λ) of the particular detection region ij for the color c at the wavelength λ, the following applies:
$${{𝒫}_{n} [ O ]}_{ij , c} ≡ \int ⅆ x \int ⅆ y \int ⅆ z {\int }_{0}^{∞} ⅆ λ \cdot {E}_{c} ( λ ) \cdot O ( λ , x , y , z ) \cdot {P}_{n , ij} ( λ , x , y , z ) ,$$
and,
in a third step, for a second operator
$$\{ + {\sum }_{\begin{matrix}m \\ m \neq n\end{matrix}} {𝒫}_{m} {𝒫}_{n}^{- 1} \} ,$$
using the order of diffraction n of the useful light and the orders of diffraction m≠n and the one-operator [symbol] , the inverse or pseudo-inverse
$$K = {\{ + {\sum }_{\begin{matrix}m \\ m \neq n\end{matrix}} {𝒫}_{m} {𝒫}_{n}^{- 1} \}}^{- 1}$$
is determined as the error correction operator K.

22. The method according to claim 17, wherein the error correction operator is determined through calculation using technical data of the optical device.

23. The method according to claim 17, wherein the error correction operator is determined using technical data obtained through measurement of the optical device.

24. An imaging device, in particular a digital camera, having at least one optical imaging unit for imaging an object onto an image recording unit assigned to the imaging unit and having a processing unit connected to the image recording unit, the image recording unit having a number of detection regions for detecting intensity values, which are representative of the intensity of the light incident on the detection region when imaging the object, wherein, to reduce errors upon imaging an object using the imaging unit, the processing unit is adapted to determine a corrected intensity value B_{ij,c,corr} by applying an error correction operator K determined for the imaging unit to the actual intensity value B_{ij,c} detected in the respective detection region, the error correction operator K being stored in a first memory connected to the processing unit.

25. The imaging device according to claim 24, wherein the imaging unit comprises at least one imaging diffractive element and the error correction operator is a stray light correction operator K for correcting stray light effects when imaging the object onto the image recording unit.

26. The imaging device according to claim 24, wherein the processing unit is adapted to determine the error correction operator K for the imaging unit using stored technical data of the imaging unit.

27. The imaging device according to claim 25, wherein the processing unit is adapted to determine the error correction operator K for the imaging unit,
by being adapted to determine the continuous point spread function Pₘ(λ,x,y,z,x′,y′) of the imaging unit and the discrete point spread function
$${P}_{m , ij} ( λ , x , y , z ) = {\int }_{{y}_{j}^{′} - Δ {y}_{j}^{′}}^{{y}_{j}^{′} + Δ {y}_{j}^{′}} {\int }_{{x}_{i}^{′} - Δ {x}_{i}^{′}}^{{x}_{i}^{′} + Δ {y}_{i}^{′}} {P}_{m} ( λ , x , y , z , {x}^{′} , {y}^{′} ) ⅆ {x}^{′} ⅆ {y}^{′}$$
for the respective detection region ij and the respective order of diffraction m,
by being adapted for subsequent determination of the inverse or pseudo-inverse [symbol] ₙ⁻¹, for which, using the order of diffraction n of the useful light, the object function O(λ,x,y) describing the radiation properties of an object, and the sensitivity E_{c}(λ) of the respective detection region ij for the color c at the wavelength λ, the following applies:
$${{𝒫}_{n}^{- 1} [ O ]}_{ij , c} ≡ {[ \int ⅆ x \int ⅆ y \int ⅆ z {\int }_{0}^{∞} ⅆ λ \cdot {E}_{c} ( λ ) \cdot O ( λ , x , y , z ) \cdot {P}_{n , ij} ( λ , x , y , z ) ]}^{- 1} ,$$
and,
by being adapted for subsequent determination of the error correction operator K as the inverse or pseudo-inverse
$$K = {\{ + {\sum }_{\begin{matrix}m \\ m \neq n\end{matrix}} {𝒫}_{m} {𝒫}_{n}^{- 1} \}}^{- 1} ,$$
using the order of diffraction n of the useful light and the orders of diffraction m≠n and the one-operator [symbol] , and,
in particular being adapted for subsequent storage of the error correction operator K in the first memory.

28. The imaging device according to claim 24, wherein an output unit connected to the processing unit is provided for the output of the image of the object, the processing unit being adapted to use the corrected intensity values B_{ij,c,corr} when outputting the image of the object.
